(19) United States
(12) Patent Application Publication
(10) Pub. No.: US 2016/0349432 A1
(43) Pub. Date: Dec. 1, 2016

(54) BACKLIGHT MODULE AND LIQUID CRYSTAL DISPLAY DEVICE

(71) Applicant: HON HAI PRECISION INDUSTRY CO., LTD., New Taipei (TW)

(72) Inventors: LI-CHIAO HUANG, New Taipei (TW); CHIEN-MING HUANG, New Taipei (TW); KUAN-WEI CHOU, New Taipei (TW); YU-WEN LAI, New Taipei (TW); JOU-HSUAN WU, New Taipei (TW)

(21) Appl. No.: 15/164,885

(22) Filed: May 26, 2016

Related U.S. Application Data
(60) Provisional application No. 62/167,911, filed on May 29, 2015.

(51) Int. Cl. F21V 8/00

(52) U.S. Cl. CPC G02B 6/005; G02B 6/0055; G02B 6/0073

(57) ABSTRACT

A backlight module includes a light guide plate, a light source, and a phosphor film. The light source is secured to the light guide and includes an emitting element and a phosphor element covering the emitting element. The phosphor film includes a plurality of colored phosphor particles. The emitting element emits light with a first primary color. A lighting path is defined by the phosphor element, the light guide plate, and the colored phosphor particles, and the resulting mixed-color light is converted to a white light to illuminate a display panel. A display device with the backlight module is also provided.

### FIELD

The subject matter herein generally relates to a backlight module and a liquid crystal device using the backlight module.

### BACKGROUND

In its basic form, a liquid crystal display (LCD) does not emit light and hence requires a backlight for its function as a visual display. Light Emitting Diodes (LEDs) have been employed as light sources for backlighting LCDs. However, if the LED's luminous efficiency is not high, the display by backlight module and the display device is reduced in visibility.

### BRIEF DESCRIPTION OF THE FIGURES

Implementations of the present technology will now be described, by way of example only, with reference to the attached figures.

FIG. 1 is an exploded, isometric view of a first embodiment of a display device of the present disclosure.

FIG. 2 is an assembled isometric view of the first embodiment of a display device of the present disclosure.

FIG. 3 is a cross-sectional view of the display device of FIG. 2.

FIG. 4 is a cross-sectional view of a second embodiment of a display device of the present disclosure.

FIG. 5 is a cross-sectional view of a third embodiment of a display device of the present disclosure.

FIG. 6 is a cross-sectional view of a fourth embodiment of a display device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

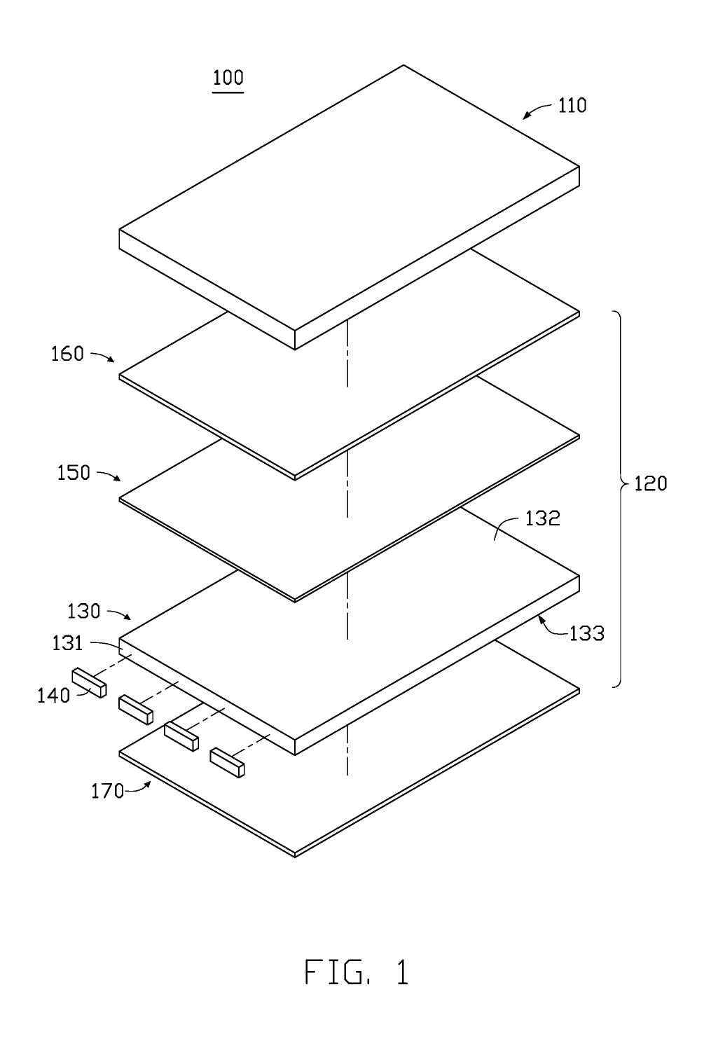

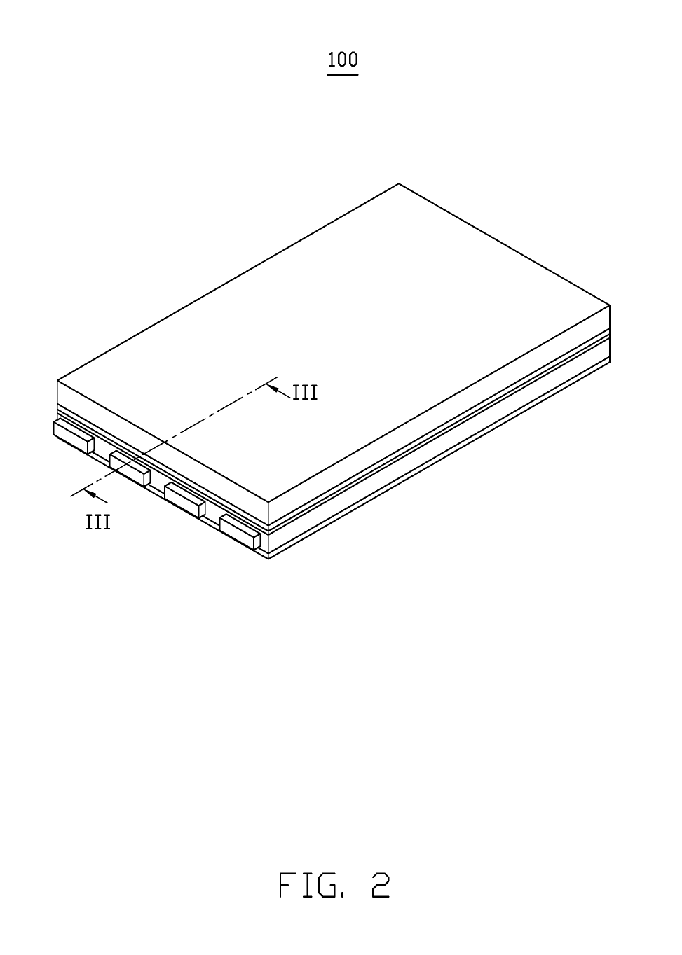

FIG. 1 illustrates a first embodiment of a display device 100 of the present disclosure, FIG. 2 illustrates the first embodiment of a display device 100 when assemble. The display device 100 includes a display panel 110, and a backlight module 120 disposed under the display panel 110. The backlight module 120 provides white light required as backlighting by the display panel 110. The display panel 110 may be a liquid crystal display panel. The backlight module 120 includes a light guide plate 130, a light source 140, a phosphor film 150, an optical film 160, and a reflector 170.

The light guide plate 130 has a light incident surface 131, a light emitting surface 132 adjacent to the light incident surface 131, and a bottom surface 133 opposite to the light emitting surface 132. The light source 140 is disposed beside the light incident surface 131, the phosphor film 150 is disposed beside the light emitting surface 132, and the reflector 170 is disposed beside the bottom surface 133. The optical film 160 is disposed beside the phosphor film 150 away from the light guide plate 130 and sandwiched between the phosphor film 150 and the display panel 110.

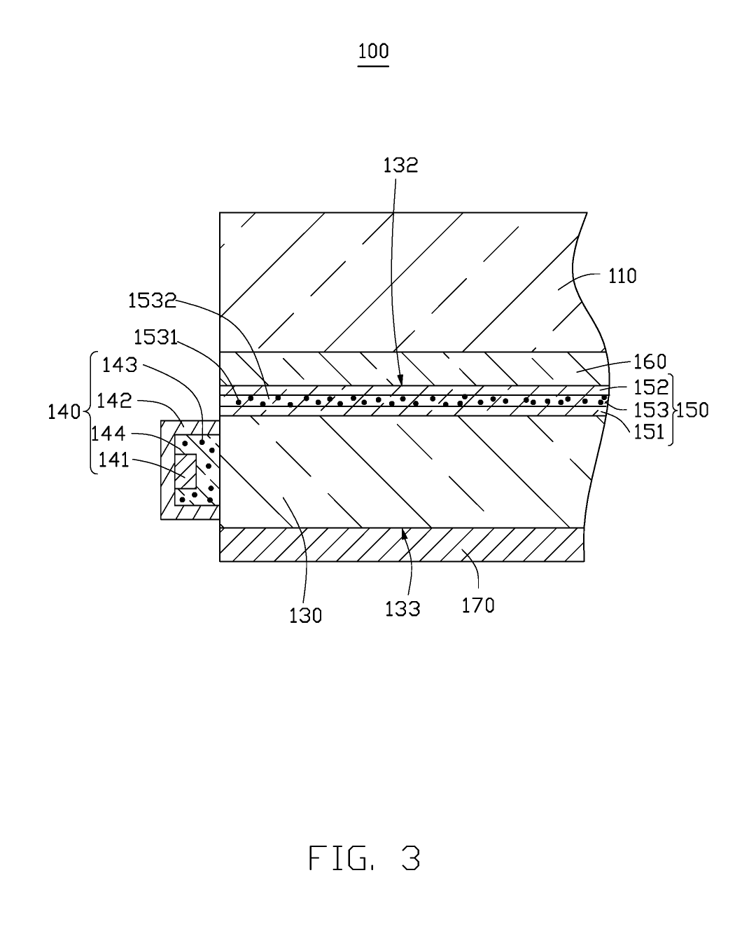

FIG. 3 illustrates the display device 100 in cross section. In at least one embodiment, the light source 140 may be a light emitting diode comprising a package body 142, an emitting element 141 fixed in the package body 142, and phosphor element 143 distributed in the package body 142 and covering the emitting element 141. It is understood that the phosphors 143 can be mixed with a base material 144 to form a sealing compound covering the emitting element 141. The emitting element 141 is configured to provide light with a first primary color. In this embodiment, the emitting element 141 is a light emitting diode chip emitting blue light, and the first primary color is blue with wavelength of approximately 458-480 nanometers. The phosphors 143 and the emitting element 141 are integrally formed. The phosphors 143 may directly cover the emitting element 141 or may be disposed in the package body 142, such that the light from the emitting element 141 is emitted through the phosphor element 143. In this embodiment, the phosphors 143 have a second primary color, and the second primary color is red. In other words, the phosphors 143 may be red. The red phosphor material may include Mn⁴⁺or Eu²⁺, such as K₂SiF₆: Mn⁴⁺, Ca₂Si₅N₈: Eu²⁺, Sr₂Si₅N₈: Eu²⁺, Ca₂AlSiN₃: Eu²⁺, CaS: Eu²⁺. Mg₂TiO₄: Mn⁴⁺K₂TiF₆: Mn⁴⁺or others.

A portion of the light with the first primary color excites the phosphors 143 to generate light with the second primary color. The light with the second primary color mixes with light of the first primary color such that the light source 140 emits a mixed light of the first primary color and the second primary color. In one embodiment, the emitting element 141 is a light emitting diode chip emitting blue light, the phosphors 143 is red, and the light source 140 thus emits mixed blue and red light.

The mixed blue and red light passes through the light incident surface 131 into the light guide plate 130 and leaves the light guide plate 130 through the light emitting surface 132 to go out. The mixed blue and red light from the light emitting surface 132 of the light guide plate 130 is provided to the phosphor film 150. The reflector 170 reflects light leaking from the bottom of the light guide plate 130 back to the light guide plate 130.

The phosphor film 150 may include a bottom barrier layer 151, a top barrier layer 152, and a phosphor layer 153 located between the bottom barrier layer 151 and the top barrier layer 152. The bottom barrier layer 151 and the top barrier layer 152 protect the phosphor layer 153. The phosphor layer 153 has base material 1531 and a plurality of phosphors 1532 located in the base material 1531. The base material 1531 can be transparent, and the phosphors 1532 can output light of a third primary color.

In this embodiment, the third primary color is green. In other words, the phosphor layer 153 is a green phosphor layer and has a plurality of green phosphors 1531. The material of the green phosphors 1531 may include SrGa₂S₄: Eu²⁺, and the proportion of phosphors 1531 in the phosphor layer 150 can be range from 5%˜20%. Moreover, a thickness of the phosphor layer 153 can be in a range from 5˜50 um, and a thickness of each of the bottom barrier layer 151 and the top barrier layer 152 can be in a range from 5˜50 um. Accordingly, a thickness of the phosphor film 150 can be in a range from 15˜150 um.

The optical film 160 may be a diffuser or a brightness enhancement film. In at least one embodiment, the optical film may not be required, and then white light emitted from the phosphor film 150 may be directed directly toward the display panel 110. In this embodiment, the optical film 160 is a dual-brightness enhancement film (D-BEF) or a brightness enhancement film-reflective polarizer (BEF-RP). A part the mixed light from the light guide plate 130 excites the phosphor film 150 to generate white light, and the white light is provided to the display panel 110 via the optical film 160. The other part of the mixed light from the light guide plate 130 is reflected to the light guide plate 130 by the optical film 160, reflected by the reflector 170, and as a second tranche is provided to the optical film 160. Accordingly, the other part of the mixed light can be changed to white light by the optical film 160, and the white light is provided to the display panel 110 via the optical film 160. Each of the first primary color, the second primary color, and the third primary color are different, each being a monochrome color.

The backlight module 120 generates white light when the light of the emitting element 141 excites the phosphor element 143 and the phosphor film 150.

The first light conversion in the light source 140 and the second light conversion in the phosphor film 150 are delivered substantially separate from each other, and the light conversion efficiency of the two conversions is thereby improved. Furthermore, because the optical film 160 can reflect part of the mixed light from the light guide plate 130 to the light guide plate 130 by the optical film 160, and the light guide plate 130 and the reflector 170 can provide the other part of the mixed light to the optical film 160 as the second tranche, the light conversion efficiency of the backlight module 120 and the liquid crystal panel are also improved. Luminous efficiency and brightness the backlight module 120 and the liquid crystal panel are thus improved.

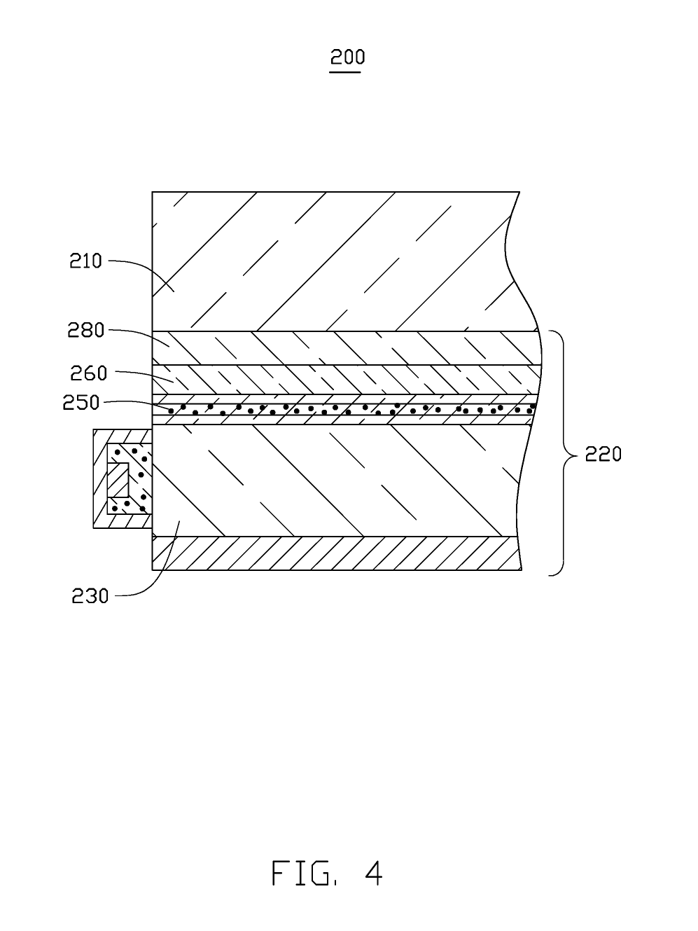

FIG. 4 illustrates a second embodiment of a display device 200 of the present disclosure. The display device 200 includes a display panel 210, and a backlight module 220 disposed under the display panel 210. The display device 200 is similar to the display device 100 of the first embodiment but the display device 200 comprises two optical films 260 and 280. The optical film 260 and the optical film 280 are disposed on the phosphor film 250 away from the light guide plate 230 and sandwiched between the display panel 210 and the phosphor film 250. Each of the optical film 260 and the optical film 280 may be a diffuser or a brightness enhancement film. In this embodiment, the optical film 280 is a dual-brightness enhancement film (D-BEF) or a brightness enhancement film-reflective polarizer (BEF-RP), and the optical film 260 may be a diffuser or a brightness enhancement film.

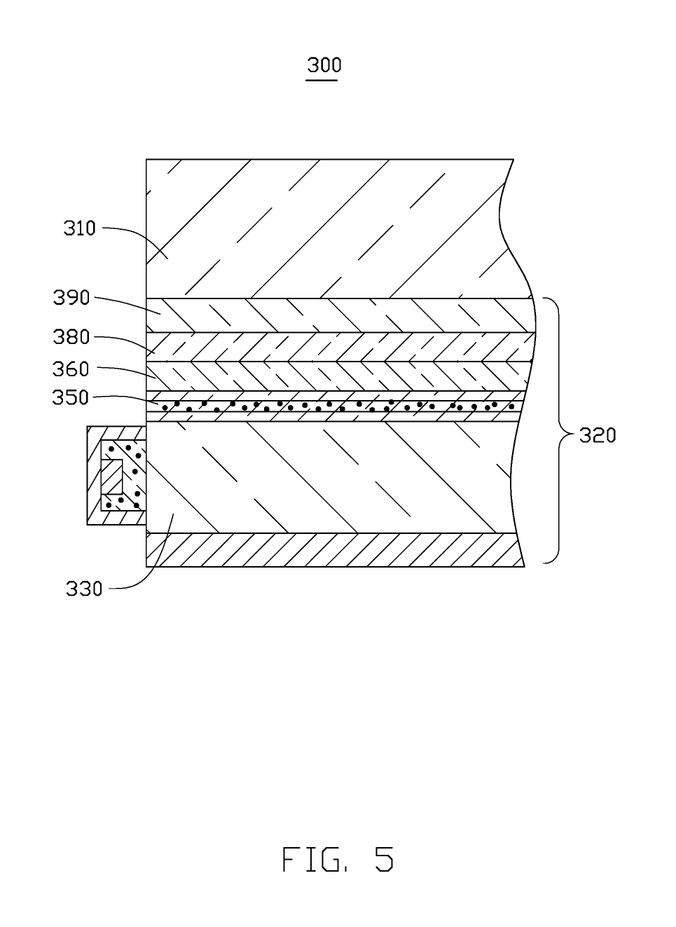

FIG. 5 illustrates a third embodiment of a display device 300 of the present disclosure. The display device 300 includes a display panel 310, and a backlight module 320 disposed under the display panel 310. The display device 300 is similar to the display device 100 of the first embodiment but the display device 300 comprises three optical films 360, 380, and 390. The optical film 360, the optical film 380, and the optical film 390 are disposed on the phosphor film 350 away from the light guide plate 330 and sandwiched between the display panel 310 and the phosphor film 350. Each of the optical film 360, the optical film 380, and the optical film 390 may be a diffuser or a brightness enhancement film. In one embodiment, the optical film 390 is a dual-brightness enhancement film (D-BEF) or a brightness enhancement film-reflective polarizer (BEF-RP), and the optical films 360 and 380 may be a diffuser or a brightness enhancement film.

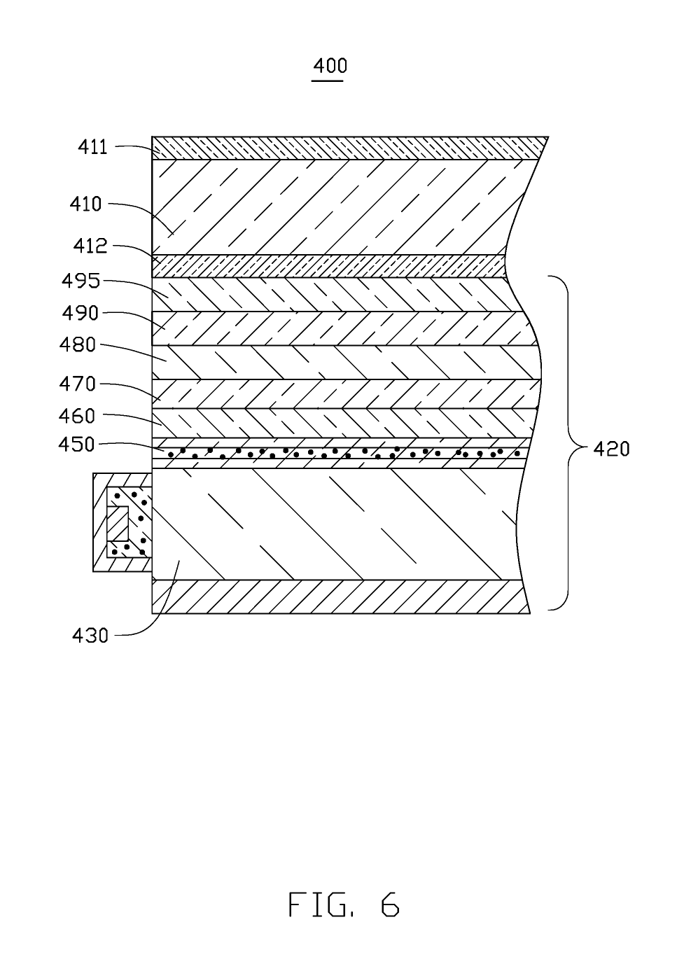

FIG. 6 illustrates a fourth embodiment of a display device 400 of the present disclosure. The display device 400 includes a display panel 410, and a backlight module 420 disposed under the display panel 410. The display device 400 is similar to the display device 100 of the first embodiment but the display device 400 comprises five optical films 460, 470, 480, 490, and 495. The optical films 460, 470, 480, 490, and 495 are disposed on the phosphor film 450 away from the light guide plate 430 and sandwiched between the display panel 410 and the phosphor film 450. In one embodiment, the optical film 495 is an advanced polarizer film (APF) which can be attached to a lower surface of a display panel, and each of the optical films 460, 470, 480, and 490 may be a diffuser or a brightness enhancement film. In detail, the display device 400 further comprises a top polarizer 411 and a lower polarizer 412, these being disposed on two sides of the display panel 410. The optical film 495 is attached to a lower surface of the lower polarizer 412. Alternatively, the optical film 495, functioning as an advanced polarizer film, can carry out the function of the lower polarizer 412. The brightness enhancement structure of the advanced polarizer film can be integrated into the lower polarizer 412 to obtain an equivalent function.

While various exemplary and preferred embodiments have been described the disclosure is not limited thereto. On the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A backlight module, configured to supply light to a display panel, comprising:
a light guide plate;
a light source secured to the light guide and comprising an emitting element and a plurality of first phosphors covering the emitting element; and
a phosphor film comprising a plurality of second phosphors;
wherein the emitting element is configured to emit light with a first primary color; a lighting path is defined by the first phosphors, the light guide plate, and the second phosphors, and the light with a first primary color is converted to a white light to be reflected to the display panel.

2. The backlight module of claim 1, wherein the light source further comprises a package body, and the emitting element is fixed in the package body.

3. The backlight module of claim 2, wherein the plurality of phosphors is mixed within a base material to form a seal compound covering the emitting element.

4. The backlight module of claim 2, wherein the emitting element is a blue light emitting diode chip, and the first primary color is blue with wavelength 458-480 nanometers.

5. The backlight module of claim 1, wherein the phosphor film comprises a phosphor layer, which has base material and the plurality of second phosphors mixed in the base material.

6. The backlight module of claim 5, wherein each phosphor film further comprises a bottom barrier layer and a top barrier layer, and the phosphor layer is located between the bottom barrier layer and the top barrier layer 152; and the bottom barrier layer and the top barrier layer are configured to protect the phosphor layer.

7. The backlight module of claim 1, wherein the color of the plurality of first phosphors is red, and the color of the plurality of second phosphors is green.

8. The backlight module of claim 1, wherein the color of the plurality of first phosphors is green, and the color of the plurality of second phosphors is red.

9. The backlight module of claim 1, further comprising at least one optical film attached to the phosphor film, wherein each optical film is a dual-brightness enhancement film or a brightness enhancement film-reflective polarizer.

10. The backlight module of claim 1, further comprising a reflector attached to a bottom end of the light guide plate, wherein the reflector is configured to reflect light leaking from the bottom of the light guide plate back to the light guide plate.

11. A display device comprising:
a display panel; and
a backlight module comprising:
a light guide plate;
a light source secured to the light guide and comprising an emitting element and a plurality of first phosphors covering the emitting element; and
a phosphor film comprising a plurality of second phosphors;
wherein the emitting element is configured to emit light with a first primary color; a lighting path is defined by the first phosphors, the light guide plate, the second phosphors, and the display panel; and the light with a first primary color is converted to a white light to be reflected to the display panel.

12. The display device of claim 11, wherein the light source further comprises a package body, and the emitting element is fixed in the package body.

13. The display device of claim 12, wherein the plurality of phosphors is mixed within a base material to form a seal compound covering the emitting element.

14. The display device of claim 12, wherein the emitting element is a blue light emitting diode chip, and the first primary color is blue with wavelength 460-475 nanometers.

15. The display device of claim 11, wherein the phosphor film comprises a phosphor layer, which has base material and the plurality of second phosphors mixed in the base material.

16. The display device of claim 15, wherein each phosphor film further comprises a bottom barrier layer and a top barrier layer, and the phosphor layer is located between the bottom barrier layer and the top barrier layer 152; and the bottom barrier layer and the top barrier layer are configured to protect the phosphor layer.

17. The display device of claim 11, wherein the color of the plurality of first phosphors is red, and the color of the plurality of second phosphors is green.

18. The display device of claim 11, wherein the color of the plurality of first phosphors is green, and the color of the plurality of second phosphors is red.

19. The display device of claim 11, further comprising at least one optical film attached to the phosphor film, wherein each optical film is a dual-brightness enhancement film or a brightness enhancement film-reflective polarizer.

20. The display device of claim 11, further comprising a reflector attached to a bottom end of the light guide plate, wherein the reflector is configured to reflect light leaking from the bottom of the light guide plate back to the light guide plate.
